(19) United States
(12) Patent Application Publication
(10) Pub. No.: US 2007/0224323 A1
(43) Pub. Date: Sep. 27, 2007

(54) Sugar Replacement and Baked Goods and Caramels Using the Sugar Replacement

(76) Inventor: Fred Goldman, Boynton Beach, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/690,419

(22) Filed: Mar. 23, 2007

Related U.S. Application Data
(60) Provisional application No. 60/785,197, filed on Mar. 23, 2006.

(51) Int. Cl. A23L 1/236

(52) U.S. Cl. 426/548

(57) ABSTRACT

A sugar replacement includes a mixture of agave inulin and agave fructose. The agave inulin forms from 40 to 90 percent by weight of the sugar replacement. The agave fructose forms a remainder (10 to 60 percent by weight) of the sugar replacement. The sugar replacement has reduced calories and glycemic index compared to sugar. The sugar replacement can have its sweetness adjusted so that it is a one to one replacement for sugar. This is particularly useful when the sugar replacement is being used in baking recipes. Baked goods and caramels using the sugar replacement have qualities like those using sugar. The sugar replacement can be used to make chocolates.

### CROSS-REFERENCE TO RELATED APPLICATIONS

This application claims the benefit of U.S. Provisional Application No. 60/785,197, filed Mar. 23, 2006 the contents of which is incorporated herein by reference thereto.

### STATEMENT REGARDING FEDERALLY SPONSORED RESEARCH OR DEVELOPMENT

Not Applicable

### THE NAMES OF PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to sweeteners and sugar replacements using inulin derived from the agave plant. The invention relates in particular to sugar substitutes that can be used in baked goods and confectioneries.

2. Description of the Related Art

Most artificial sweeteners, such as saccharin and aspartame, have 180 to 300 times the sweetness of an equivalent dose of sucrose. Sucralose is a sweetener six-hundred times (600×) sweeter than sugar. Therefore, food processors obviously will compensate by using a much lower volume of these artificial sweeteners in their low calorie foods than the volume of sugar that they replace. With dry goods (such as baked products), food processors are forced to “back fill” the volume of the removed sugar that the artificial sweeteners do not replace. This back fill product is referred to as a “bulking agent.” Bulking agents are found in a variety of products, including chewing gums, confectioneries, baking mixes, meat products, and packets containing the artificial sweetener in amounts equivalent of one or more teaspoons of sugar. The optimal bulking agents should bring the physical and chemical characteristics of sugar back to the food without reintroducing calories or contributing significantly to product cost.

Bulking agents are evaluated against the following criteria:
1. Significantly fewer calories than sucrose, glucose, or fructose;
2. Physical and chemical properties that match those of sucrose in all food applications;
3. Mouth feel comparable to sugar;
4. Freedom from adhesion to lips and tongue;
5. Freedom from toothpack (i.e. freedom from packing into crowns of teeth);
6. Demonstrated existence of secondary health benefits;
7. No negative side effects: i.e. completely safe at reasonable levels of consumption;
8. Freedom from caking and clumping in the dry product; and
9. Freedom from desolation or fractionation upon standing in the wet product.

More specifically, in order to effectively replace sucrose and fructose and their organoleptic qualities, potential bulking agents must display the following characteristics: safe, stable, low calorie, minimal gastrointestinal side effects, low cost, no off-flavors, high solubility, low viscosity, crystalline, ability to brown, and protein/starch interactions similar to sucrose.

Prior-art sugar replacements were particularly bad for making hard candy. Sugar alcohols have been the only known sugar replacements to make hard candy. Unfortunately, sugar alcohols produce products with significant laxative effects and are therefore not considered a viable substitute for the general public, especially children.

Inulin is a general class of substitute sweeteners. Inulin has the following formula:

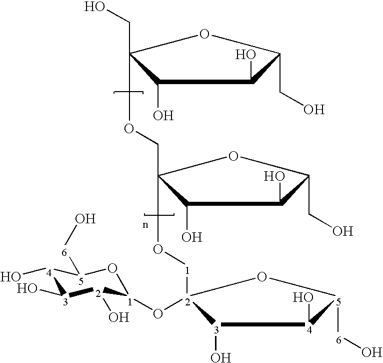

The size and degree of branching of the inulin molecule depend on its source and processing. n denotes the degree of polymerization or “units” of the inulin. Inulins are a group of naturally occurring oligosaccharides (several simple sugars linked together) produced by many types of plants. They belong to a class of carbohydrates known as fructans. Inulin is used by some plants as a means of storing energy and is typically found in roots or rhizomes. Most plants which synthesize and store inulin do not store other materials such as starch. Inulin is used increasingly in foods, because it has unusual nutritional characteristics. Inulin ranges from completely bland to subtly sweet and can be used to replace sugar, fat, and flour. This is particularly advantageous because inulin contains one-third to one-fourth the food energy of sugar or other carbohydrates and one-sixth to one-ninth the food energy of fat. It also increases calcium absorption and possibly magnesium absorption, while promoting intestinal bacteria. Nutritionally, it is considered a form of soluble fiber, and it is important to note that consuming large quantities (particularly for sensitive and/or unaccustomed individuals) can lead to gas and bloating. Inulin has a minimal impact on blood sugar, making it generally considered suitable for diabetics and potentially helpful in managing blood sugar-related illnesses.

U.S. patent application Ser. Nos. 10/971,264, 11/020,742, and 11/244,026, which all have identical inventors as the instant application, are incorporated by reference. These applications teach sugar replacements, chocolate comestibles, and baked goods that utilize inulin along with other sweeteners and bulking agents to make sugar replacements.

U.S. Pat. No. 5,659,028 issued to Coussement et al. describes branched fructo-oligosaccharides. Coussement et al. describe the need for bulking agents and the shortcomings of linear fructo-oligosaccharides. It is explained that longer-chain linear fructo-oligosaccharides, like inulin, have less osmetic side effects than shorter chain; however, problems caused by the complete degradation of (longer and shorter-chain) linear fructo-oligosaccharides still remain. The application also recognizes the longstanding difficulty in synthesizing branched oligosaccharides from agave.

U.S. Pat. No. 5,998,177 to Catani describes a process for enzymatically processing sucrose into glucose. Branched inulins, which comprise a linear chain of β-2,1-linked fructose chains, linked to an α-D-glucoised having branched thereon β-2,6 fructose units. Such a branched inulin material has been reports having been isolated form the sap of the blue agave plant. Catani also recognized that the properties of inulin depend on the chain length and degree of branching. Catani cross-references German patent application DE 40 03 140 A1, which discusses using such branched inulins as sugar substitutes. While branched fructans are suggested as a bulking agent for foods and sweeteners, no examples or combinations are specified.

U.S. Pat. No. 5,846,333 to Partida et al. discloses a method of producing fructose syrup from agave plants. The patent teaches the enzymatic conversion of inulin from agave, but does not teach other applications for the inulin, itself, as a sweetener.

U.S. Pat. No. 7,001,624 to Golz describes a method of feeding inulin to improve health in young animals. The inulin discussed can be derived from agave and is characterized as a fructan with β2-1 linkages. Inulin is useful for feeding to animals because it is a soluble dietary fiber.

U.S. Pat. No. 6,569,488 to Silver discloses a process for providing inulin products that are soluble at ambient temperatures to aid in their use as foodstuffs. In particular, Silver teaches to use the specially adapted inulin as a bulking agent.

### BRIEF SUMMARY OF THE INVENTION

It is accordingly an object of the invention to provide a sugar replacement that overcomes the above-mentioned disadvantages of the heretofore-known compositions and methods of this general type.

The invention encompasses sugar replacements that include mixtures of inulin from agave (i.e. “agave inulin”) and fructose from agave (i.e. “agave fructose). While mixing of separate agave inulin with agave fructose is possible, a preferred way of obtaining the mixture is to control or interrupt the conversion of agave inulin to agave fructose. The conversion reaction is typically conducted using enzymes.

With the foregoing and other objects in view there is provided, in accordance with the invention, a sugar replacement. The sugar replacement is essentially a mixture of agave inulin and agave fructose. The agave inulin forms from 40 to 90 percent by weight of the sugar replacement. The agave fructose forms a remainder (10 to 60 percent by weight) of the sugar replacement.

It is an object of the invention to provide a sugar replacement for making foodstuffs that show improvements in the following properties compared to other sugar replacements:

improved solubility at ambient temperatures;

reduced hygroscopicity;

reduced tendency to cake and clump as a sugar substitute bulking agent;

reduced formation of undesirable sticky substances in the mouth when used as a bulking agent;

improved miscibility with water without formation of sticky clumps or lumps when used as a bulking agent;

improved water solubility and/or water miscibility at ambient temperatures; and

increased prebiotic fiber content (up to 80%).

A further object of the invention is to provide a new use for the Blue Weber agave plant, which is used to make tequila.

In accordance with the objects of the invention, a new sugar substitute includes agave extract. The agave extract is a fructose syrup with lower calories and lower glycemic index (as compared to sucrose). The agave extract is commercially available from a Mexican tequila manufacturer.

Research by the Applicant showed that variable mixtures of fructose and inulin could be extracted from agave at different time phases in the enzymatic conversion. Manufacturers of agave fructose had never considered interrupting the conversion. The resulting syrup of mixtures of agave inulin and agave fructose are far more stable and evenly distributed compared to mixtures by mixing separate agave inulin with agave fructose.

Agave inulin is significantly different to the conventional inulin extracted from the Jerusalem artichoke and the chicory root. Conventional inulin is a long chain oligofructosacharide of approximately 15 to 20 units long. Agave inulin is a branched chain oligofructosacharide, approximately 15 to 20 units long. Because each branch is 15 to 20 units long, agave inulin has a total 30 to 40 units: double that of the conventional inulin. The size and branched structure of the agave inulin is believed to give the agave inulin improved characteristics to agave from other sources. The improved characteristics include a reduced laxative effect and increased palatability. Agave inulin also has a caramelization temperature that is identical to sugar; this makes agave inulin a very effective sugar replacement in baking and confectioneries.

Further investigation and experimentation resulted in successful production of this agave inulin in both syrup and powder format. The samples of agave-based inulin produced were sweeter than existing chicory inulin or alternative inulins produced from other plants.

Mixtures of agave inulin and agave fructose were developed. Mixtures within the following ranges were found to have satisfactory taste, sweetness, and mixing capability:
40-90% of agave inulin; and
10-60% agave fructose.

The agave mixture (i.e. agave inulin versus agave fructose) can be adjusted to control the ratio for replacing sugar (i.e. agave mixture to sugar ratio). By adjusting the agave inulin to agave fructose amounts, the sugar-replacement ratios can be adjusted between 1:1 to 1:5.

Alternative High Intensity Sweeteners (HIS) can be added to agave sweeteners. HIS were found to have synergistic sweetening effects. The inclusion of HIS allows further adjustment of the two major ingredients (i.e. the agave inulin and the agave fructose) to achieve a 1:1, 2:1, or 5:1 comparison in sweetness to sugar.

If extra browning capacity is required for certain baked products, a small percentage of maltodextrin can be added to achieve this browning effect.

In accordance with a further object of the invention, a sweetener according to the invention can be made as syrup, powder, or a crystal. As stated, agave inulin is much sweeter than other inulins. The greater sweetness allows the ingredients of the sweetener to be more adjustable (i.e. wider possible ranges) than sweeteners using other inulins. The greater adjustability allows formulations in the various states: i.e. syrup, powder, or crystal.

The resulting sweeteners using agave inulin have higher fiber, reduced calories, and lower Glycemic value. In addition, the sweeteners carry the attributes of inulin and prebiotic fiber, which include a level of satiety and increased calcium absorption.

Possible High Intensity Sweeteners (HIS) include natural sweeteners such as Lo Han, NHDC, thaumatin, stevia, and taglatose. By combining a natural HIS with the replacement sweetener, an “all-natural” product results. Also possible are more common HIS's such as aspartame, saccharin, acesulfame potassium, sucralose, and the like.

A substitution of regular inulin (i.e. non-agave inulin) in the mixture results in a unique blend but requires either a greater percentage of agave fructose or a greater percentage of HIS to achieve the same level of sweetness. Likewise, non-agave fructose can be added to the sugar replacement.

The replacement of the agave fructose with alternative forms of fructose would work, again with a lower level of sweetness that could be supplemented by HIS.

The introduction of alternative High Intensity Sweeteners (HIS), were found to be a good synergistic level, and permitted further adjust %'s of the two major ingredients, the agave inulin and the agave fructose to achieve a 1:1 or 2:1 or 5:1 etc. comparison in sweetness to sugar. See HIS discussion above.

Pertinent facts and figures discriminating agave inulin from traditional chicory and Jerusalem artichoke inulin are discussed herein. Primarily, agave inulin is a branched chain, while the other inulins are linear chains. As a result, they have different breakdown and water retention levels, which significantly affect the way they react in products and within the body.

A further object of the invention is to provide a sugar replacement using a combination of agave inulin and agave fructose.

A further object of the invention is to provide a sugar replacement that can be used to replace the sugar in baked goods. A further object is to provide a sugar replacement that replaces sugar on a one-to-one basis by weight for easy substitution in recipes.

The sugar replacement should be usable to sweeten creams, jellies, chocolate, hard candies, etc.

By being an effective substitute sweetener in baked goods as well as in creams and jellies, would mean that the substitute sweetener could provide a complete solution for a low glycemic range of baked products.

Other features which are considered as characteristic for the invention are set forth in the appended claims.

Although the invention is exemplified and described herein as embodied in a sugar replacement, it is nevertheless not intended to be limited to the details shown, because various modifications and structural changes may be made therein without departing from the spirit of the invention and within the scope and range of equivalents of the claims.

The composition and method of using the invention, however, together with additional objects and advantages thereof will be best understood from the following description of specific embodiments when read in connection with the accompanying examples.

### BRIEF DESCRIPTION OF THE SEVERAL VIEWS OF THE DRAWING

Not applicable

### DETAILED DESCRIPTION OF THE INVENTION

Before beginning, all percentages given within this application are weight percentages unless otherwise specified.

Testing was conducted on different mixtures of agave inulin combined with agave fructose. Mixtures including forty to ninety weight percent (40-90% wt) of agave inulin combined with ten to sixty weight percent (10-60% wt) agave fructose all yielded a satisfactory taste, sweetness, and mixing capability. The mixtures replace sugar at ratios of sweetener to sugar of 1:1, 1:2, or 1:5.

Sugar substitutes were created by mixing or extracting agave inulin and agave fructose. The mixtures includes from 40% to 90% of agave inulin by weight. A balance of the mixture (i.e. 60% -10% by weight) is agave fructose. These sugar substitutes have fewer calories and a lower glycemic index than sugar.

Sugar has a caloric value of four calories per gram (4 Cal/g) and a GI of 66. Of course, sugar has a sweetness level (i.e. replacement level by sweetness) of 1:1 with itself.

The following table summarizes the results for the various sugar replacement mixtures.

| | Agave | Agave | | | Sweetness |
|---|---|---|---|---|---|
| Example | Inulin (%) | Fructose (%) | Cal/g | GI | Level |
| 1 | 40 | 60 | 1.84 | 29.6 | 1:1 |
| 2 | 60 | 40 | 1.56 | 22.4 | 3:5 |
| 3 | 90 | 10 | 1.14 | 11.16 | 1:5 |

The sweetness level of the sugar replacement can be adjusted to 1:1 by including a High Intensity Sweetener (HIS) or combination of high intensity sweeteners. Example 3 from the previous table had the fewest calories and lowest GI of the examples. Example 3 also gives the highest fiber and prebiotic fiber of the examples and is made with natural ingredients. The sweetness level of Example 3 was manipulated by adding at least one HIS.

| | | | | SWEETNESS |
|---|---|---|---|---|
| HIS 1 | % HIS 1 | HIS 2 | % HIS 2 | LEVEL |
| Neohesperidene | 0.3 | | | 1:1 |
| Stevia | 0.9 | | | 1:1 |
| Sucralose | 0.9 | | | 1:1 |
| Stevia | 0.3 | Acesulfame | 0.6 | 1:1 |
| | | Potassium | | |
| Lo Han | 0.6 | | | 1:1 |

Other possible HIS include aspartame, acesulfame-K, cyclamates, saccharin, sucralose, neohesperidin dihydrochalone, alitame, stevia sweeteners, glycyrrhizin, thaumatin, and xylotol, Lo Han, and the like. Preferred HIS, include acesulfame-K 0.2 % and neohesperidin dihydrochalone 1.0%. As an alternative, 0.2% sucralose may be used. Additional sweeteners such as neotame, tagatose, and trehalose may be used.

In the experiments described above, the type of agave inulin used was purchasable from Agaviotica under the trade names FRUCTAGAVE PR95 and FRUCTAVAGE SP70, and FRUCTOOLIGOSACCHARIDE (FOS). These products are fructans from the Blue Agave plant. Agave fructose is commercially available from Agaviotica; the high fructose (HF) that is preferred is syrup from tequilana weber agave that is concentrated at 70 degrees, brix. Another source for the sugar replacement was a 60% agave fructose/40% agave inulin mixture that was extracted as a finished syrup during the enzymatic process.

The sugar replacement was used to produce the following examples of bake goods.

### Pound Cake

A pound cake was baked using the sugar replacement instead of sugar. While such a substitution may appear simple, pound cake is used as a test for a sugar replacement in baked goods because the batter is required to be whipped. Prior-art sugar replacements have not been able to produce pound cake. In the example, the browning of the pound cake was excellent. The resulting cake was moist just below the outer surface; this is necessary to keep the cake from becoming too dry. The pound cake was also noted as having what appeared to be sugar crystals forming on the top of the cake: again something that has only previously been seen from sugar. The only criticism was that the pound cake rose to between 90 and 95% of the volume of a similar cake made with sugar. The volume difference was acceptable, especially considering the browning and similar surface appearance.

### Cupcakes

Cupcakes were baked using the sugar replacement to replacement the sugar in the batter of the cupcakes and to replace the sugar in the frosting. The cupcakes had satisfactory body, moisture content, and color.

In both examples (pound cake and cupcakes), the preferred sugar substitute was a mixture of 60% agave fructose and 40% agave inulin. When the inulin percentage was increased, the color, browning, and especially texture began to degrade. A substitute sweetener using 40% agave fructose and 60% agave inulin was the limit to the mixture to be a useful replacement that produced satisfactory looking cake. Increasing the fructose percentage in the substitute sweetener beyond 60% caused the cake to become too moist and too sweet; this was expected as fructose is 1.4 times the sweetness of sugar. In other applications, a sugar replacement using a mixture of 90% agave fructose and 10% agave inulin would be an upper working limit of agave fructose, but realistically 80% agave fructose and 20% agave inulin is about as far as tolerable in most test subjects.

### Caramel

Caramels and toffees were made replacing the sugar in a conventional recipe with the sugar substitute that included agave inulin and agave fructose.

The resulting caramel was stiff and brittle, similar to caramels made with sugar. The caramel was also transparent. This was unexpected. The resulting caramels did not show the laxative effect shown by hard candies using sugar alcohols.

When caramel was made using a sugar replacement with 60% agave fructose and 40% agave inulin, the caramel was more of a soft caramel. When a caramel was made using a sugar replacement with 80% agave fructose and 20% agave inulin, the caramel was relatively hard and crisp, identical to caramel made from sugar.

The caramel using the replacement sugar caramelized at 154° C. This is the same caramelization temperature as sugar. This is another reason why the sugar replacement is such a good sugar replacement for baking and confectionary. The claims appended hereto are meant to cover modifications and changes within the scope and spirit of the present invention.

I claim:

1. A sugar replacement, comprising:
agave inulin; and
agave fructose.

2. The sugar replacement according to claim 1, wherein:
said agave inulin forms from 40 to 90 percent by weight of the sugar replacement; and
said agave fructose forms a remainder of the sugar replacement.

3. The sugar replacement according to claim 1, wherein said agave inulin and said agave fructose are derived from a Blue Weber agave plant.

4. The sugar replacement according to claim 1, wherein said agave inulin is a branched oligofructosacharide having at least two branches, each of said branches being from 15 to 20 units in size.

5. The sugar replacement according to claim 1, wherein said agave inulin and said agave fructose are syrups.

6. The sugar replacement according to claim 1, wherein said agave inulin and said agave fructose are powders.

7. The sugar replacement according to claim 1, further comprising a high intensity sweetener.

8. The sugar replacement according to claim 7, wherein an amount of said high intensity sweetener is added to produce a one to one sweetness level of the sugar replacement to sugar.

9. The sugar replacement according to claim 7, wherein said high intensity sweetener is selected from the group consisting of neohesperidin dihydrochalone (NHDC), thaumatin, stevia, taglatose, aspartame, saccharin, acesulfame potassium, sucralose, neohesperidene, acesulfmae-K, cyclamates, alitame, glycyrrhizin, xylotol, Lo Han, neotame, tagatose, and trehalose.

10. The sugar replacement according to claim 2, further comprising no more than 0.3% of neohesperidene.

11. The sugar replacement according to claim 2, further comprising no more than 0.9% of stevia.

12. The sugar replacement according to claim 2, further comprising no more than 0.9% of sucralose.

13. The sugar replacement according to claim 2, further comprising:
no more than 0.3% of stevia; and
no more than 0.6% of acesulfame potassium.

14. The sugar replacement according to claim 2, further comprising no more than 0.6% of Lo Han.

15. The sugar replacement according to claim 1, further comprising maltodextrin.

16. The sugar replacement according to claim 1, further comprising non-agave inulin.

17. The sugar replacement according to claim 16, further comprising a high-intensity sweetener.

18. The sugar replacement according to claim 1, further comprising non-agave fructose.

19. The sugar replacement according to claim 1 having a sweetness level between 1:1 and 1:5 of sugar replacement to sugar.

20. A baked good, comprising the sugar replacement according to claim 2.

21. A caramel, comprising the sugar replacement according to claim 2.
